(19) United States
(12) Patent Application Publication
(10) Pub. No.: US 2009/0164252 A1
(43) Pub. Date: Jun. 25, 2009

(54) NATIONAL ONLINE MEDICAL MANAGEMENT

(75) Inventors: Brian Morris, Montreal West (CA); Kamal Mekhael, Westmount (CA); Alain Gourd, Gatineau (CA); Roberto Bellini, Westmount (CA); Joseph Mekhael, Westmount (CA); David Brochu, Ste-Julie (CA); Hugh J. Moulton, Westmount (CA); Raymond Luk, Montreal (CA); Gary Green, Narberth, PA (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: DOCTORDIRECT.COM, INC., Westmount (CA)

(21) Appl. No.: 12/061,106

(22) Filed: Apr. 2, 2008

Related U.S. Application Data
(60) Provisional application No. 61/015,373, filed on Dec. 20, 2007.

(51) Int. Cl. G06Q 10/00

(52) U.S. Cl. 705/3

(57) ABSTRACT

The online method for managing scheduling of, payment for and accounting of a medical management transaction available over a global system for a patient and a health care provider, includes providing a database server, providing an application server on which the medical management system resides, providing payment processing services, exchanging regulated data with a medical services government agency, accessing electronic medical records services by the patient, including uploading existing medical records by the health care provider and the patient, commenting on accessed records by the patient to provide patient comments, storing the patient comments in the system and providing the patient comments to the health care provider along with records requested by the health care provider.

### BACKGROUND OF THE INVENTION

1. Field of Invention

This invention relates to the field of information systems and in particular to web-based health care management.

2. Description of Related Art

Providing patients with secure access to electronic medical records would improve medical care and efficiency. It would allow both parties to ensure accuracy and reduce malpractice claims. However, providing access to static medical information provides only a partial solution; the ability to interact immediately with that medical record content, respond to errors and provide a medium that facilitates and encourages dialogue between patient and physician would revolutionize health care efficiency and quality.

Currently, patients who wish to consult their medical records are faced with many challenges, such as the fact that information is often dispersed among different physicians and specialists, and that records are often paper-based and hand-written, resulting in information that is both difficult to access and to read.

Existing online scheduling applications currently do not address the issue of patient medical record access. This results in a scheduling system that does not provide the patient with the necessary medical information for making informed appointments. Access to medical records, tests results and prescription information would allow the patient to make informed medical decisions, such as scheduling a follow-up appointment based on test results or scheduling an evaluation appointment when a prescription is approaching expiration.

Furthermore, a secure communication module that would allow patients and physicians to discuss the content of the medical record would provide important benefits to both parties are provided. For example, patients could provide further clarification in the event of a misunderstanding or note errors in symptoms or treatment reported during a visit. Improvement in health care efficiency would result from the reduction of needless visits, such as when only simple questions need to be asked (e.g., medical history, questions regarding treatment or medication).

Another disadvantage of existing online scheduling applications is that they are limited to providing services in a closed system, such as for a single medical practice or geographical location. This results in a scheduling system that is not easily accessible to all members of the population and that does not offer the benefits of medical record centralization and migration.

There is a need for a single system providing a complete medical management solution, accessible by both patients and physicians, which include access to and the ability to interact with medical records, scheduling, automated notifications, billing and a central repository of physicians and patients at a national level.

All references cited herein are incorporated herein by reference in their entireties.

### BRIEF SUMMARY OF THE INVENTION

The invention provides an integrated approach to medical management services, which includes online patient access to medical records, patient and physician interaction, scheduling, appointment management, automated notifications and billing directly to government agencies for regulated provincial services.

The invention allows patients, who are considering an appointment, to have access to their latest medical information so as to be able to make better medical decisions and to empower them to take an active role in their treatment.

For instance, patients could consult their medical file to verify when a follow-up appointment was supposed to be scheduled or to verify whether the physician made a note of his or her symptoms during the last visit and whether there were any errors or omissions. The patient could also verify whether test results were received and would be able to consult the results. The file could also serve as a reminder to patients, in terms of medication history, allergies, symptoms and conditions.

If the patient notices an error while reviewing the medical record (e.g., the patient reported extreme pain in the left arm during their last visit, but the medical report states the right arm), the patient can access the physician's virtual office and leave a note of the error. Alternatively, the patient may have some additional questions regarding treatment or have some additional medical history to provide. Rather than scheduling an additional medical appointment, the patient simply communicates the additional information to their physician via the secure discussion forum. An online chat module allows for additional real-time dialogue between physician and patient.

Another major advantage of the invention over the prior art is that it is not limited to a single medical office nor to a single geographical location. Instead, it connects medical professionals and patients at a national level; it is easily extensible to different state or provincial health laws and regulations.

The national scope of the application provides the benefit of a unique searchable directory of physicians that allows patients to search for physicians based on proximity or specialty. The directory also allows physicians to search for new patients, based on location or medical condition, in order to allow them to build their practice. Another benefit of a national system is that of providing a way to easily migrate medical records when patients change physicians or move to another geographic location.

The current invention targets medical practices only, providing additional benefits specific to the medical industry that other systems lack. For instance, the system integrates with validation services that verify the credentials of a medical professional upon registration. In addition, the system provides an electronic referral method permitting medical professionals to refer their patients to specialists electronically. Specialists can then share their calendar with the patient and invite them to schedule an appointment. Furthermore, the system is fully compliant with medical industry standards such as HIPPA, RAMQ and HL7.

The invention allows for at least four different types of users: First, patients access the system to consult their medical information, search for physicians, view a physician's availability, create or cancel appointments and to accept or refuse an invitation from a physician for an appointment. Second, physicians can manage all aspects of their schedule, create electronic referrals to specialists and manage all billing aspects of their practice. Physicians can also search for patients and synchronize their schedule with external software, such as Microsoft Outlook. Third, medical assistants can access the system, manage the physician's schedule, and handle administrative tasks such as billing for medical services. Fourth, system administrators manage the centralized medical management server for all patients and physicians using the system. Their role is to provide support to patients and physicians who are encountering system related problems, to ensure that the system is operating properly and to verify and validate a physician's credentials.

The system is also integrated with multiple billing mechanisms. For instance, patients are automatically charged via credit card when they do not show up for appointments. Furthermore, the system integrates with multiple state or provincial government agencies allowing physicians to bill directly for eligible medical procedures.

Another advantage of the invention is that the system lightens the workload of medical assistants by automating a variety of tasks. For instance, the system automatically sends out notifications, via email or telephone, when physicians make changes to their schedule. Patients can proceed to reschedule the cancelled appointment online, without the interaction of an assistant. Another example is that of managing appointment reminders, which consume a lot of an assistant's time. The system constantly monitors upcoming appointments and an innovative automated voice system sends out customized appointment reminders to patients over the telephone.

An additional advantage of the system is that it can integrate with other administrative medical software or it can act as a stand-alone application providing all the necessary administrative functions required by a medical practice. This also means that medical offices have no additional software to install or to manage.

Accordingly, disclosed is a secure online application and method providing centralized health care management services for patients and medical professionals at a national level. The system can provide features such as electronic medical records (EMR), scheduling, automated appointment notifications, referrals and billing services. Patients can use the system to consult, schedule appointments and, in some cases, correct their medical records, search for physicians, obtain referrals or obtain automated referrals. Medical practitioners and their assistants can manage the administrative aspects of their practice including scheduling, patient management, referrals and billing. The system integrates with multiple government health care systems using standard protocols for data exchange and allowing medical professionals to bill directly to the applicable government agency and manage payments. Further, the system interfaces transparently with other third party services and software applications, using a scalable and flexible architecture, in order to manage patient medical records, synchronize data, perform validations, transmit customized voice notifications, and process credit card payments.

The online method for managing scheduling of, payment for and accounting of a medical management transaction available over a global system for a patient and a health care provider, includes providing a database server, providing an application server on which the medical management system resides, providing payment processing services, exchanging regulated data with a medical services government agency, accessing electronic medical records services by the patient, including uploading existing medical records by the health care provider and the patient, commenting on accessed records by the patient to provide patient comments, storing the patient comments in the system and providing the patient comments to the health care provider along with records requested by the health care provider.

The functionalities of the invention are thus accessible by both medical professionals and patients. The system integrates electronic medical records, scheduling, electronic referrals, automated reminders and billing modules with multiple external web services, applications and transport technologies. Additionally, the system provides a unique dynamic medical record dialogue mechanism allowing patients to communicate directly with their physicians online in order to clarify, correct and interact with medical information transcribed by their physicians.

Further advantages will become apparent in the following detailed description of the invention.

### BRIEF DESCRIPTION OF SEVERAL VIEWS OF THE DRAWINGS

The invention will be described in conjunction with the following drawings in which like reference numerals designate like elements and wherein:

FIG. 1A is a high-level view of one embodiment of the method and system of the present invention.

FIG. 1B is a detailed representation an embodiment of the method and system of the present invention.

FIG. 2A is a flow diagram depicting the patient-side of accessing the method and system of the present invention.

FIG. 2B is a flow diagram depicting the registered patient-side process of managing appointments within the method and system of the present invention.

FIG. 3A is a flow diagram depicting the physician/assistant-side process of registering and logging into the method and system of the present invention.

FIG. 3B is a flow diagram depicting the physician/assistant-side process of managing aspects of scheduling and making referrals within the method and system of the present invention.

### DETAILED DESCRIPTION OF THE INVENTION

The invention relates to a computer method and system connected over a global network providing a central location for patients to consult their medical records and test results, search for physicians of their choice in a global directory, view physicians' schedules and book their own appoints. The system also provides a central location for physicians to interact with each other as well as with their patients, share their schedules and manage appointments. The system provides more than scheduling and online appointment management; it also provides a complete integrated medical management system that includes integration with a variety of external services, applications and transport mediums to provide access to electronic medical records, billing, payment processing, physician validation, patient validation, fraud prevention, electronic referrals and a method to easily extend the service across different provincial medical regulations to provide a truly seamless national medical management system.

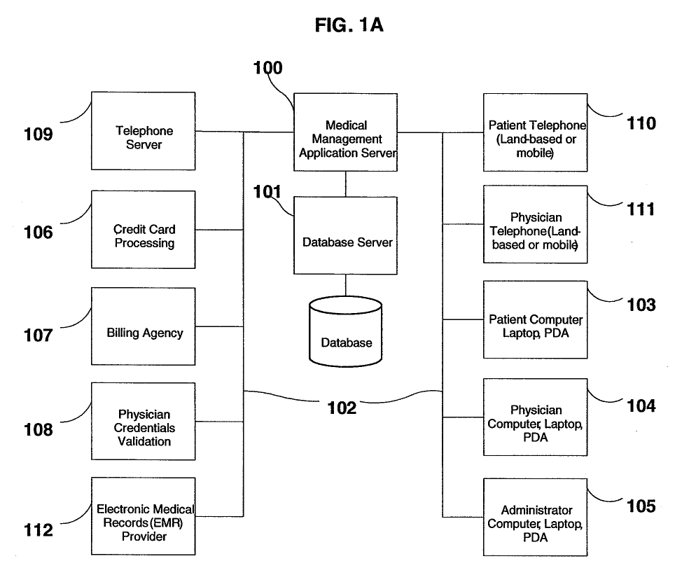

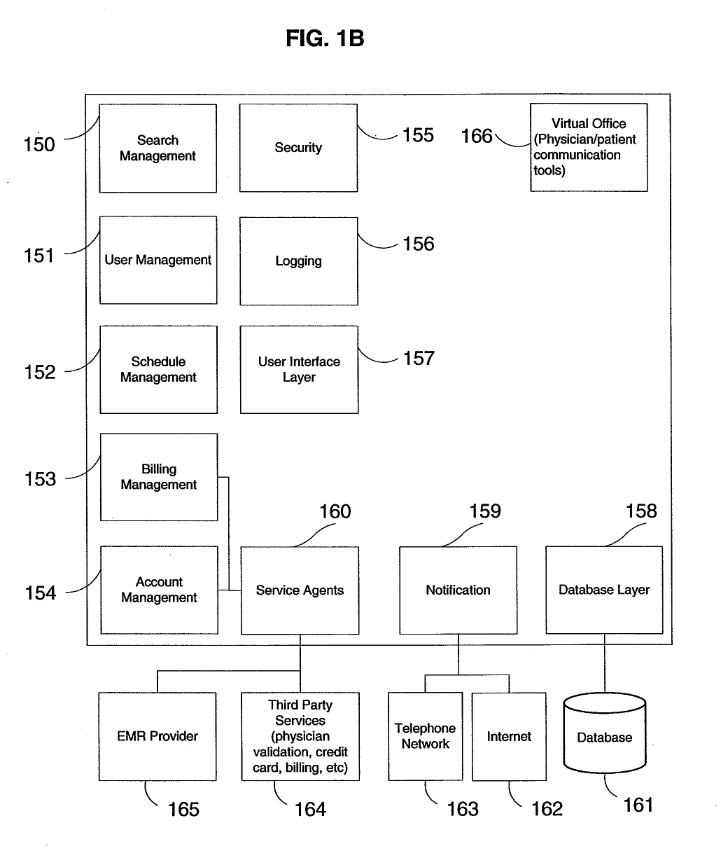

Referencing FIG. 1A, the method for managing a medical management system includes an application server 100 which is connected to a database server 101. The application server 100 can be connected to a global network 102, such as the internet. The medical management system also includes computers used by patients 103, physicians 104 and system administrators 105. Computers accessing the medical management system can be connected to the Internet 102 through a wired connection, a wireless connection or a combination of wired and wireless connections. The term computer is used in a general sense and can include many forms of internet-enabled devices, such as laptops, desktop computers, mobile phones, tablet computers and personal digital assistants.

The medical management system also includes multiple external servers that are integrated with the system to provide functions such as credit card processing 106, medical billing to multiple government health care agencies 107, validation services 108 to validate physician credentials upon registration, and electronic medical records consultation 112. These external servers are also connected to the global network 102. The system also connects to the telephone and mobile phone networks 109 in order to send automated and personalized voice notifications to patients 110 and physicians 111 on their land-based or mobile telephones.

FIG. 1B provides a detailed view of the application's major components. The application is comprised of the following modules: Search Management 150, User Management 151, Account Management 154, Schedule Management 152 and Billing Management 153. The Search Management module 150 provides advanced search capabilities for both patients and physicians. Since the system centralizes physicians located across the nation, patients can be provided with a complete directory of physicians. Patients, for example, can search for a physician according to their location, name or specialty. Likewise, physicians can search the patient directory and authorize selected patients to make appointments. The User Management module 151 provides functions for managing the different types of system users—patients, physicians, medical assistants and system administrators. The Account Management module 154 handles all services dealing with the registration process, electronic referral management and the management of account preferences, such as notification preferences. The Schedule Management module 152 provides all the scheduling-related functions such as calendars, booking appointments, managing schedules and cancellations. The Billing Management module 153 handles all services dealing with billing and payment processing either through credit card processing or through interaction with government health agencies. The Virtual Office 166 provides patient—physician online communication and interactive tools to facilitate dialogue. This includes a secure forum whereby a patient may post messages, such as questions or additional medical information, to the physician or enter into a live online chat session.

The Database Layer 158 contains code and libraries allowing the application to interact with the database. This module contains code to perform database operations such as creating, deleting, searching and modifying data. The Security module 155 contains code for encrypting and decrypting system access passwords, user medical and personal information and credit card data. The function of the Logging module 156 is to log system activities and errors. The User Interface Layer 157 contains all the code for generating the application's user-friendly graphical interface.

The system is also comprised of a notification module 159 that sends out personalized notifications to physicians and patients over the telephone network 163 or over the Internet via email 162 in response to system events. For example, the system detects upcoming appointments automatically and sends reminders to patients by phone or by email, according to their preference, in order to reduce the chances of missed appointments. Physicians can also receive notifications, for example, each time a patient cancels an appointment or as a reminder of an upcoming appointment.

The system is also comprised of modular components called Service Agents 160. These components are responsible for interacting directly with external providers 164, such as credit card processing providers, automated voice providers, validation services, government servers and EMR vendors 165. A Service Agent is modular source code that has been extracted from the main application source code due to its variable nature. This makes it is easy to add or change external providers, which are integrated with the system, without requiring changes to the main application source code. Adding a new provider is as simple as adding a new customized Service Agent that will encode data for transmission to the provider using the required protocol.

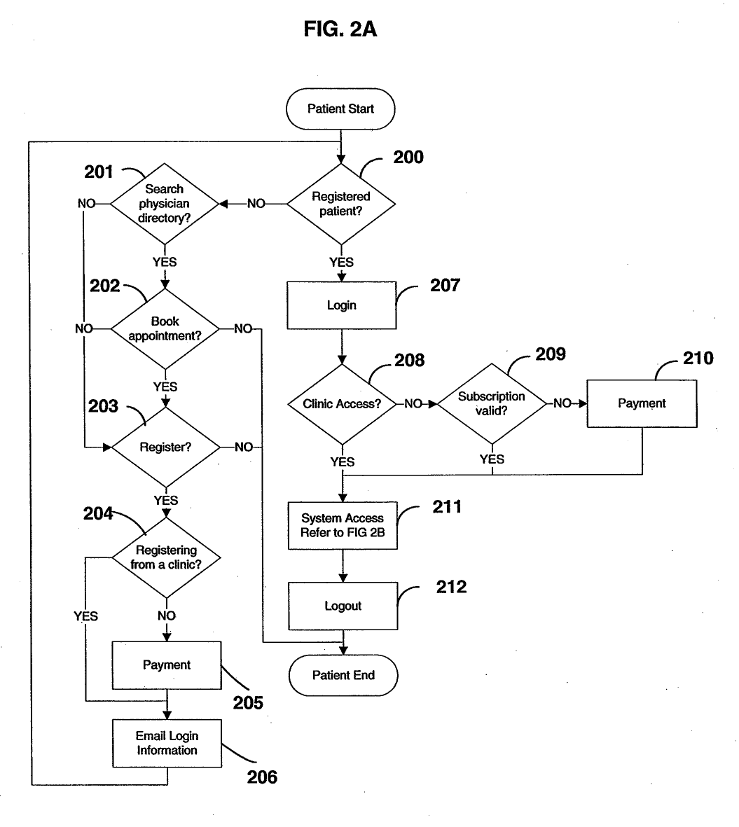

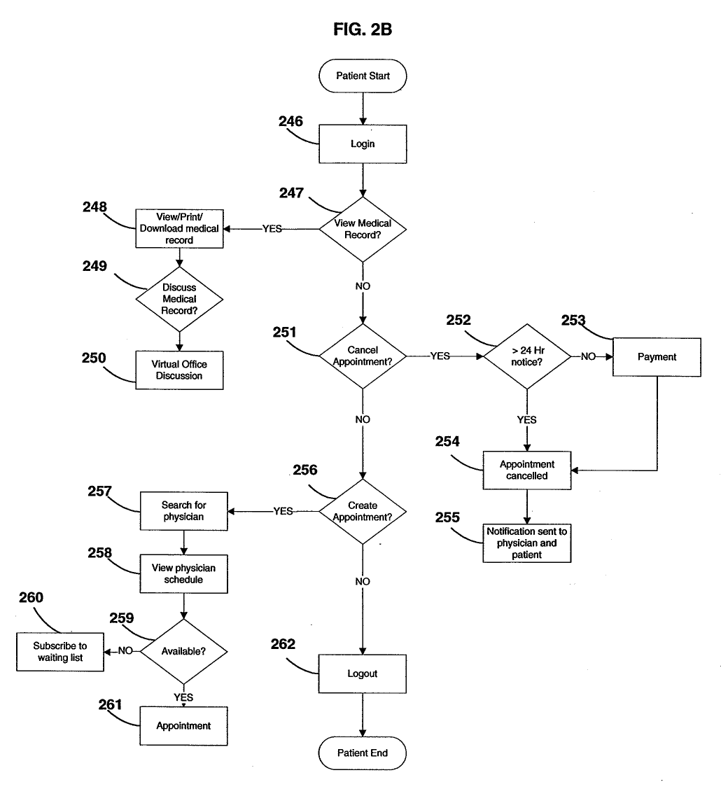

Referring to FIG. 2A, the patient accesses the system's website from an external link or by entering the website's URL directly in their browser. The non-registered patient 200 may perform searches on the physician directory 201. If the non-registered patient wishes to book an appointment with a physician 202, then the patient must first register 203. The system will automatically detect whether the patient is registering from a computer terminal located in a clinic 204. In this case, the system does not proceed to request credit card information. Otherwise, patients registering outside of a clinic must select a subscription plan and provide credit card information 205. According to the medical insurance number, the system will automatically detect the age of the user; patients under 14 years of age require parental approval to register. The system will display a checkbox requiring parental approval before validating the registration request. Upon successful registration, the system interacts with an external service to processes any applicable credit card payments 205. The system then sends an automated email confirmation to the patient 206.

Patients who have successfully registered with the system can then proceed to login 207 to the system from the web site's home page. The patient must enter the user name and password that were chosen during the registration process. The system will automatically detect whether the patient is accessing the system from a clinic 208. If not, the system will automatically verify whether the patient's subscription plan is valid 209. If the subscription plan is valid, the patient may proceed to the system's patient menu 211. Otherwise, the patient must provide credit card information and the system will process the subscription plan payment 210 before continuing to the system's patient menu 211. The patient can then log out 212 of the system once they have completed their activities.

Referring to FIG. 2B, the patient who has successfully logged into the system 246 can access the system's patient menu. The patient has the option of consulting his or her medical record 247. If this option is selected 248, the system displays a window asking the patient the time frame of data to be displayed (e.g., 5 days, 1 month, 6 months, 1 year). After selecting the desired time frame and correctly completing identification information for security purposes, the medical record can then be viewed securely online, downloaded into a standard format (such as PDF or Microsoft Word) or, if the patient is on a public computer, the record can be sent via encrypted email. If the patient identifies errors, omissions, has questions or has additional medical information to convey to the physician 249, he or she can select “virtual office” 250 and create a secure message. The system can send an automated alert informing the physician of the new message.

The “virtual office” is a secure messaging module enabling communications between the physician and the patient. The functionality for communicating corrections or other messages from a user patient reviewing a patient record of any type can be similar to email in that users can create and view messages using an interface that is similar to a typical email client, such as Microsoft Outlook. Unlike email, however, the messages can remain within the system where they are stored securely in the database and no email addresses are required. To send a message to a physician, the patient can select the desired physician from a list of available physicians (i.e., the system displays only the patient's physician(s)), enters a subject, summarizing the purpose of the message and then composes the message. The message can specify a particular laboratory or test result, doctor or other health care provider comments or diagnoses in addition to merely being a general comment or explanation of symptoms or questions or requests for services. The patient clicks “send message,” and the system can send an automated alert informing the physician of the new message. The message can be separate from the medical record; if the physician wishes to append the contents of the message to the medical record, it can be done manually by any authorize person in the system.

If the patient wishes to cancel an appointment 251, the patient selects “view agenda” from the menu. The system displays the patient's upcoming appointments. The patient selects the appointment to cancel and the system displays the appointment details. The patient clicks on the “cancel appointment” button to cancel the appointment. The system proceeds to verify whether the cancellation is being done within 24 hrs of the scheduled appointment 252. If it is 253, the system can issue an additional message that charges could apply to the cancelled appointment and that charges can be automatically be applied to the patient's credit card. The patients can confirm they wish to cancel the appointment. The system cancels the appointment 254 and performs any credit card transactions 253, if required. The system sends a notification of cancellation to both the patient and the physician 255. Alternatively, the patient can also cancel an appointment when they receive a reminder email for an upcoming appointment by clicking the link provided in the email.

At decision point 256, the patient can decide whether to schedule an appointment. The patient can first select a physician by performing a search for a physician 257 based on a number of possible criteria, such as physician name, specialty, affiliated hospital/clinic, physician availability (date, day of week or time period) or proximity to a location specified by the patient (e.g., the patient's home or work). The system returns a list of all the physicians matching the supplied search criteria. The patient can then proceed to view a physician's schedule 258 by clicking on a physician in the list. If the physician is unavailable 259 during the desired time frame, the patient can subscribe to the physician's waiting list 260. In this case, the system can automatically send a notification to the patient when the physician becomes available for additional appointments. If the physician is available 259, the patient can then book an appointment with the physician by clicking on the desired time slot on the physician's calendar 261. The system asks the patient to confirm the appointment and warns the patient that a charge will be applied for missed appointments or cancellations with less than 24 hours warning. The patient can accept the appointment and the system can send a confirmation notification to the patient. The patient can then log out of the system 262.

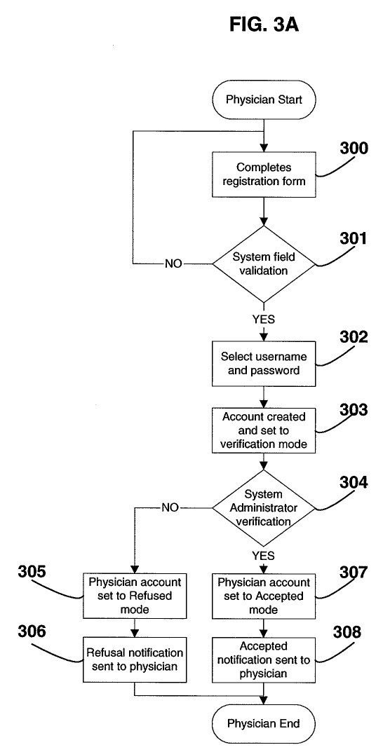

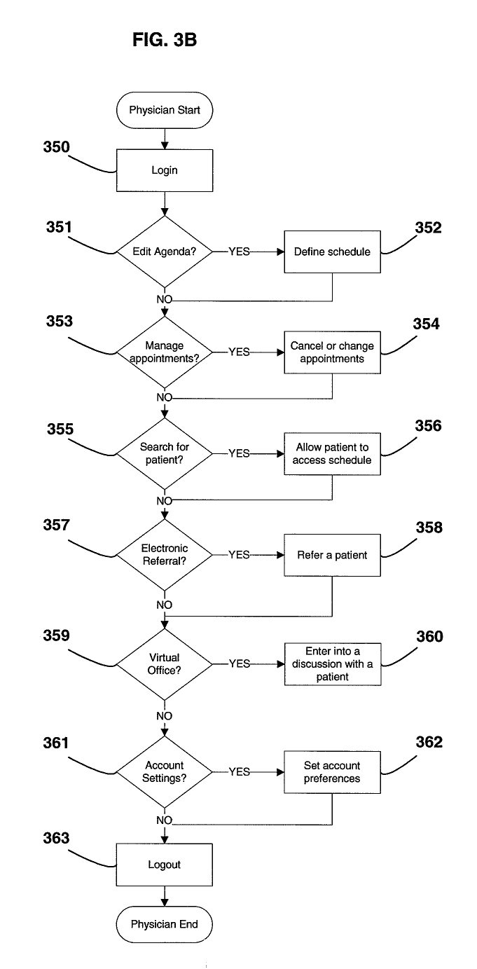

In order to use the system, the physician can complete a registration and validation process, as described in FIG. 3A. The physician can access the registration page from the physician main menu. The system displays a registration form for the physician to complete 300. The system can perform a validation on the submitted fields 301, and if there are any errors, redisplays the registration form to the physician with an error message indicating which fields need correction. Once they system validates all the fields, the system displays a second form in which the physician must select a username and password 302. The system can automatically create an account and sets it to “verification mode” 303, preventing the physician from using the system until medical credentials have been verified. The system administrator receives a notification that a new physician has registered. The system administrator logs into the administration tools, selects the physician from a list of pending registrations, and verifies the physician with an external service. If the physician is validated, the system administrator changes the physician's account status to “accepted mode” 307. The system sends an automated notification 308 by telephone or email to the physician indicating that the account has been activated. If the physician's credentials are not valid, the system administrator sets the status of the account to “refused mode” 305. The system can automatically send a notification to the physician indicating that the registration request has been refused 306.

FIG. 3B describes the physician process of scheduling and managing appointments. Physicians who have successfully registered with the system can login 350 from the website's home page by entering a user name and password. Referring to decision block 351, the physician can access the agenda in order to define available blocks of time 352. The physician selects the desired time slots from the calendar to make them available for patient appointments. The system displays a form containing the start date and time, end date and time, lunch start and end time, appointment type (such as 15, 30 minute appointments), personal notes, location of the appointment and how often the schedule is repeated, such as daily, weekly, monthly or yearly. After the physician completes the form, the system validates the fields to ensure that there are no conflicting appointments and, if not, saves the affected time slots. The physician can also elect to make certain appointments visible or invisible to patients. This allows the physician to use a single calendar application to manage both professional and personal events and selectively share calendar events with their patients.

The physician can decide to manage appointments 353, such as cancel or change appointments 354. To cancel an appointment, the physician navigates to the calendar page and selects the cancellation date. The system displays a list of appointments scheduled for the selected date range. The physician confirms to cancel the affected appointments. The system can assign a “Closed” status to the affected time slots in order to prevent new appointments from being made and assigns a “Cancelled” status to all affected appointments. The system can then automatically send notifications to all affected patients.

Physicians can change appointments to another date in order to fill up empty time slots 354. In order to change appointments to another date, the physician selects the appointments to be moved and then specifies a target date in which to move the appointments. The system can automatically send an email or voice notification to the affected patients. The patient can either accept or refuse the new appointment date directly from the notification.

The physician can search for patients 355 and invite them to make an appointment 356. The physician can access the patient search page and provide some or all of the following patient search criteria: name, birth date, medical insurance number or physician-assigned patient number and submits the form. The system returns a list of all the patients matching the given search criteria. The physician can select a patient from the list and view available information, such as contact information and all historical data for a given patient, as it relates to the physician performing the search, such as whether the patient can view the physician's calendar, past and upcoming appointments and any electronic referrals made by the physician. The physician can decide to share his or her calendar in order to allow the patient to book appointments. An automatic notification can then be sent to the patient.

The system can also provide the functionality of making electronic referrals 357. The physician can use the system to search for the patient's medical file. The physician then selects “electronic referral” from the menu 358 and the system displays a form for the physician to complete. The form can contain the name of the referred physician, the reason for the referral, the priority level and any additional notes. After the system validates the form, the electronic referral is created and saved in the system. The referred physician receives an automated notification of the referral and can log into the system to view the referral details. The referred physician can then decide to share his or her schedule with the patient. Alternatively, the system can provide a method that allows physicians to set their calendars to automatically accept referrals. The system sends an automated invitation to the patient to make an appointment with the referred physician. The physician can then print the electronic referral for paper-based records.

The physician can enter into the “virtual office” 359 in order to view messages posted by a patient and respond to their inquiries in a secure environment. Additionally, the physician may enter into a live chat session (Instant Messaging) with the patient to discuss their medical record or answer questions.

Finally, the physician can customize account preferences 361, such as defining how system notifications are received and setting the system to automatically synchronize the appointment schedule with external calendar software 362. The physician can then log out of the system 363.

While the invention has been described in detail and with reference to specific examples thereof, it will be apparent to one skilled in the art that various changes and modifications can be made therein without departing from the spirit and scope thereof.

What is claimed is:

1. An online method for managing scheduling of, payment for and accounting of a medical management transaction available over a global system for a patient and a health care provider, comprising:
a) providing a database server;
b) providing an application server on which the medical management system resides;
c) providing a payment processing service;
d) exchanging regulated data with a medical services government agency;
e) accessing electronic medical records services by the patient, including uploading existing medical records by the health care provider and the patient;
f) commenting on accessed records by the patient to provide patient comments;
g) storing the patient comments in the system; and
h) providing the patient comments to the health care provider along with records requested by the health care provider.

2. The method for managing a medical management transaction in a medical management system as recited in claim 1, further comprising scheduling a patient appointment with a health care provider by the patient.

3. The method for managing a medical management transaction in a medical management system as recited in claim 1, where the database server comprises a storage device that permanently stores patient data.

4. The method for managing a medical management transaction in a medical management system as recited in claim 1, where a transport medium comprises a global network, telephone network, mobile telephone network, or a private network.

5. The method for managing a medical management transaction in a medical management system as recited in claim 1, wherein the system is managed by a central external entity other than the health care professional or the patient.

6. The method for managing a medical management transaction medical management system as recited in claim 1, further comprising viewing, printing and downloading the medical records by the patients.

7. The method for managing a medical management transaction in a medical management system as recited in claim 6, further comprising providing electronic dialogue exchange between health car providers and patients regarding medical record content.

8. The method for managing a medical management transaction in a medical management system as recited in claim 6, further comprising registering in a centralized directory by the health care provider to search for patients, define available appointment times, change schedules and communicate with the patient.

9. The method for managing a medical management transaction in a medical management system as recited in claim 6, further comprising performing searches on a national directory by the health care provider and the patient.

10. The method for managing a medical management transaction in a medical management system as recited in claim 6, further comprising integrating the system with external applications including validation of health care provider credentials, electronic medical records services, credit card processing, billing and message notification transport.

11. The method for managing a medical management transaction in a medical management system as recited in claim 6, providing the transmission of customized automated messages to system users over multiple transport mediums, which include but are not limited to the Internet, telephone and mobile telephone networks.

12. The method for managing a medical management transaction in a medical management system as recited in claim 1, wherein the user input device comprises a computer.

13. The method for managing a medical management transaction in a medical management system as recited in claim 1, wherein the user input device comprises a personal digital assistant.

14. The method for managing a medical management transaction in a medical management system as recited in claim 1, wherein the user input device comprises a mobile telephone.

15. The method for managing a medical management transaction in a medical management system as recited in claim 2, wherein the electronic medical records include physician data.

16. The method for managing a medical management transaction in a medical management system as recited in claim 2, wherein the electronic medical records include scheduling data.

17. The method for managing a medical management transaction in a medical management system as recited in claim 2, wherein the electronic medical records include billing data.

18. The method for managing a medical management transaction in a medical management system as recited in claim 2, wherein the electronic medical records include account data.
